(19) United States
(12) Patent Application Publication
(10) Pub. No.: US 2026/0150046 A1
(43) Pub. Date: May 28, 2026

(54) WAKEUP SIGNAL THAT INDICATES SCHEDULING CONFIGURATION

(71) Applicant: QUALCOMM Incorporated, San Diego, CA (US)

(72) Inventors: Jung Ho RYU, Englewood Cliffs, NJ (US); Jelena DAMNJANOVIC, Del Mar, CA (US); Igor GUTMAN, Hod HaSharon (IL); Junyi LI, Greentown, PA (US); Tao LUO, San Diego, CA (US)

(21) Appl. No.: 18/960,476

(22) Filed: Nov. 26, 2024

(51) Int. Cl. H04W 52/02; H04W 72/12; H04W 76/20

(52) U.S. Cl. CPC H04W 52/0235; H04W 72/12; H04W 76/20

(57) ABSTRACT

Various aspects of the present disclosure generally relate to wireless communication. In some aspects, a user equipment (UE) may receive an indication of one or more scheduling configurations. The UE may receive a wakeup signal (WUS) that indicates selection of a specific scheduling configuration of the one or more scheduling configurations. Numerous other aspects are described.

### FIELD OF THE DISCLOSURE

Aspects of the present disclosure generally relate to wireless communication and specifically relate to techniques, apparatuses, and methods associated with a wakeup signal that indicates a scheduling configuration.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

A user equipment (UE) operating in a wireless network may be equipped with a communication system that includes a main radio and a low power wakeup signal radio (LP-WUR) to reduce power consumption and enable low latency. Power saving and low latency are often conflicting goals, because placing one or more components into a sleep state more often to reduce power consumption also increases latency (e.g., because data cannot be transmitted and/or received while the one or more components are in the sleep state), and because reducing the time that one or more components spend in a sleep state to reduce latency can lead to increased power consumption. An LP-WUR may help balance these goals by providing a UE wakeup mechanism that uses reduced power consumption.

A UE may also operate in a connected mode discontinuous reception (C-DRX) mode based at least in part on a DRX cycle that includes a DRX on duration during which a main radio of the UE operates in an active state and a DRX sleep state during which the main radio of the UE operates in a sleep state. In this way, the UE may conserve battery power and reduce power consumption. The DRX cycle may repeat with a configured periodicity according to a DRX configuration indicated by a network node.

### SUMMARY

Some aspects described herein relate to a method of wireless communication performed by a user equipment (UE). The method may include receiving an indication of one or more scheduling configurations. The method may include receiving a wakeup signal (WUS) that indicates selection of a specific scheduling configuration of the one or more scheduling configurations.

Some aspects described herein relate to a method of wireless communication performed by a network node. The method may include transmitting an indication of one or more scheduling configurations. The method may include transmitting a WUS that indicates selection of a specific scheduling configuration in the one or more scheduling configurations.

Some aspects described herein relate to an apparatus for wireless communication at a UE. The apparatus may include one or more memories and one or more processors coupled to the one or more memories. The one or more processors may be configured to receive an indication of one or more scheduling configurations. The one or more processors may be configured to receive a WUS that indicates selection of a specific scheduling configuration of the one or more scheduling configurations.

Some aspects described herein relate to an apparatus for wireless communication at a network node. The apparatus may include one or more memories and one or more processors coupled to the one or more memories. The one or more processors may be configured to transmit an indication of one or more scheduling configurations. The one or more processors may be configured to transmit a WUS that indicates selection of a specific scheduling configuration in the one or more scheduling configurations.

Some aspects described herein relate to a non-transitory computer-readable medium that stores a set of instructions for wireless communication by a UE. The set of instructions, when executed by one or more processors of the UE, may cause the UE to receive an indication of one or more scheduling configurations. The set of instructions, when executed by one or more processors of the UE, may cause the UE to receive a WUS that indicates selection of a specific scheduling configuration of the one or more scheduling configurations.

Some aspects described herein relate to a non-transitory computer-readable medium that stores a set of instructions for wireless communication by a network node. The set of instructions, when executed by one or more processors of the network node, may cause the network node to transmit an indication of one or more scheduling configurations. The set of instructions, when executed by one or more processors of the network node, may cause the network node to transmit a WUS that indicates selection of a specific scheduling configuration in the one or more scheduling configurations.

Some aspects described herein relate to an apparatus for wireless communication. The apparatus may include means for receiving an indication of one or more scheduling configurations. The apparatus may include means for receiving a WUS that indicates selection of a specific scheduling configuration of the one or more scheduling configurations.

Some aspects described herein relate to an apparatus for wireless communication. The apparatus may include means for transmitting an indication of one or more scheduling configurations. The apparatus may include means for transmitting a WUS that indicates selection of a specific scheduling configuration in the one or more scheduling configurations.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIGS. 3A, 3B, 3C, and 3D are diagrams illustrating, respectively, a first example of a low power wakeup radio, a second example of a low power wakeup signal (LP-WUS), a third example of a first LP-WUS procedure, and a fourth example of a second LP-WUS procedure, in accordance with the present disclosure.

FIGS. 4A and 4B are diagrams illustrating a first example and a second example of discontinuous reception (DRX), in accordance with the present disclosure.

FIG. 5 is a diagram illustrating a first example, a second example, and a third example of an LP-WUS that may be used in a connected mode DRX mode, in accordance with the present disclosure.

FIG. 6 is a diagram illustrating an example of a wireless communication process between a network node and a user equipment (UE), in accordance with the present disclosure.

FIG. 7 is a diagram illustrating an example process performed, for example, at a UE or an apparatus of a UE, in accordance with the present disclosure.

FIG. 8 is a diagram illustrating an example process performed, for example, at a network node or an apparatus of a network node, in accordance with the present disclosure.

FIG. 9 is a diagram of an example apparatus for wireless communication, in accordance with the present disclosure.

FIG. 10 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

A user equipment (UE) may be equipped with a communication system that includes a main radio and a low power wakeup signal radio (LP-WUR) to reduce power consumption and enable low latency. Power saving and low latency are often conflicting goals because placing one or more components into a sleep state more often to reduce power consumption also increases latency (e.g., because data cannot be transmitted and/or received while the one or more components are in the sleep state), and because reducing the time that one or more components spend in a sleep state to reduce latency can lead to increased power consumption. Accordingly, the UE may be equipped with the LP-WUR, which may be considered a companion receiver that can be used with a main radio to reduce power consumption and latency.

A UE may also operate in a connected mode discontinuous reception (C-DRX) mode based at least in part on a discontinuous reception (DRX) cycle that includes a DRX on duration during which a main radio of the UE operates in an active state and a DRX sleep state during which the main radio of the UE operates in a sleep state. In this way, the UE may conserve battery power and reduce power consumption. The DRX cycle may repeat with a configured periodicity according to a DRX configuration indicated by a network node.

In some cases, a C-DRX mode may be configured with downlink control information with cyclic redundancy check scrambled by a power saving radio network temporary identifier (DCP), and the DCP may be used as a wakeup signal (WUS) to decrease power consumption by the UE. For instance, the UE may remain in a sleep state instead of transitioning to an active state for a DRX on duration based at least in part on the C-DRX mode being configured with an enabled DCP state. The network node may transmit a DCP to the UE to indicate whether to start an on-duration timer for an associated C-DRX cycle (e.g., and transition to an active state) and/or whether to remain in a sleep state. Based at least in part on the DCP including downlink control information (DCI) and being carried in a physical downlink control channel (PDCCH), the UE may use a main radio to receive and decode the DCP. Relative to monitoring PDCCH in a DRX on duration, the UE may consume less power via the main radio to receive and decode the DCP.

An alternative to using a DCP as a wakeup signal for a UE operating in a C-DRX mode is using an LP-WUS that enables the UE to use an LP-WUR to monitor for the LP-WUS and to transition a main radio to a sleep state. An example of a wakeup procedure that uses an LP-WUS for a UE operating in a C-DRX mode may include a network node transmitting an LP-WUS to instruct the UE that is operating in a C-DRX mode to initiate PDCCH monitoring via a main radio, the UE transitioning the main radio to an active state, the network node transmitting PDCCH that indicates scheduling information for a downlink data traffic transmission, and the UE receiving the downlink data traffic transmission using the scheduling information. Other examples may include the scheduling information indicating scheduling for an uplink data traffic transmission, and the UE transmitting the uplink data traffic transmission using the scheduling information.

Some data traffic transmissions may be based in part on a frame rate. To illustrate, extended reality (XR) may include virtual reality and/or augmented reality in which a server renders video images at a frame rate, and the video images may be transmitted, by way of a network node, as respective image frames in downlink data traffic to a UE. Alternatively, or additionally, some forms of data traffic, such as XR data traffic, may be delay sensitive and/or may be less tolerant to reception outside of a particular time window. For instance, data traffic that is received outside of the particular time window may be out of synchronization and useless to the UE. Although an LP-WUS may decrease power consumption and/or increase power savings at a UE, the use of an LP-WUS may also add time to receiving data traffic, resulting in an image frame carried in data traffic becoming invalid and/or useless and/or may lead to the image frame being discarded. To illustrate, transitioning a main radio to an active state may cause delay to when the UE may successfully receive and decode the PDCCH, and the added delay in combination with jitter may result in the UE failing to receive PDCCH and, consequently, failing to receive scheduling information. Failing to receive the scheduling information and/or failing to receive a data traffic transmission within a particular time window may render the data traffic useless and/or may result in the UE discarding the data traffic.

Various aspects relate generally to a wakeup signal that indicates a scheduling configuration, such as a reception scheduling configuration, a transmission scheduling configuration, a downlink scheduling configuration, and/or an uplink scheduling configuration. Some aspects more specifically relate to a network node indicating selection of a preconfigured scheduling configuration in the wakeup signal. In some aspects, a UE may receive an indication of one or more scheduling configurations, such as one or more downlink scheduling configurations and/or one or more uplink scheduling configurations. Other examples may include reception scheduling configurations and/or transmission scheduling configurations associated with a sidelink. For instance, the UE may receive an indication of a table that includes multiple scheduling configurations, and each scheduling configuration may include multiple parameters that indicate control information for transmitting and/or receiving a communication. The respective parameters for each scheduling configuration may be set to respective values and/or different combinations of values. Alternatively, or additionally, each scheduling configuration may be associated with a respective entry index of the table. Based at least in part on receiving the indication of the scheduling configuration(s), the UE may receive a WUS that indicates selection of a specific scheduling configuration of the multiple scheduling configuration(s). For instance, the UE may operate in a C-DRX mode and may receive, as the WUS, an LP-WUS. In some aspects, the LP-WUS may indicate the selection of the specific scheduling configuration, such as a specific downlink scheduling configuration that is associated with a downlink data traffic transmission (e.g., a physical downlink shared channel (PDSCH) transmission), and the UE may receive the downlink data traffic transmission using the downlink scheduling configuration. In other aspects, the specific scheduling configuration may indicate an uplink scheduling configuration that is associated with an uplink data traffic transmission (e.g., a physical uplink shared channel (PUSCH) transmission), and the UE may transmit the uplink data traffic transmission using the uplink scheduling configuration.

In some aspects, a network node may transmit an indication of one or more scheduling configurations. For instance, as part of establishing a connection with a UE, the network node may transmit the indication of the scheduling configuration(s) in radio resource control (RRC) signaling. Based at least in part on transmitting the indication of the scheduling configuration(s), the network node may transmit a WUS that indicates selection of a specific scheduling configuration of the scheduling configuration(s). For instance, the specific scheduling configuration may indicate a specific downlink scheduling configuration that is associated with a downlink data traffic transmission (e.g., a PDSCH transmission), and the network node may transmit the downlink data traffic transmission using the specific downlink scheduling configuration. In other aspects, the specific scheduling configuration may indicate a specific uplink scheduling information that is associated with an uplink data traffic transmission (e.g., a PDSCH transmission), and the network node may receive the uplink data transmission using the specific uplink scheduling information.

Particular aspects of the subject matter described in this disclosure can be implemented to realize one or more of the following potential advantages. In some examples, by enabling a network node to indicate a scheduling configuration in a WUS, the described techniques can be used to mitigate timing delays at a UE operating in a C-DRX mode and mitigate the UE missing a data traffic transmission. For example, the network node may indicate the scheduling configuration in the WUS and may not transmit a PDCCH that indicates the scheduling configuration. Alternatively, or additionally, the UE may not receive, and/or may skip reception of, the PDCCH. Instead, the UE may configure a transceiver based at least in part on the indicated scheduling information. Skipping reception of the PDCCH may reduce an amount of time used by the UE to receive scheduling information that enables the UE to receive a downlink data traffic transmission and, consequently, may mitigate the UE missing reception of the downlink data traffic transmission. While described with regard to a downlink scheduling configuration and a downlink data traffic transmission, other examples may alternatively, or additionally, include a WUS indicating an uplink scheduling configuration that is used by the UE for an uplink data traffic transmission, where the indication of the uplink scheduling configuration may be based at least in part on a table of multiple uplink scheduling configurations.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, XR and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

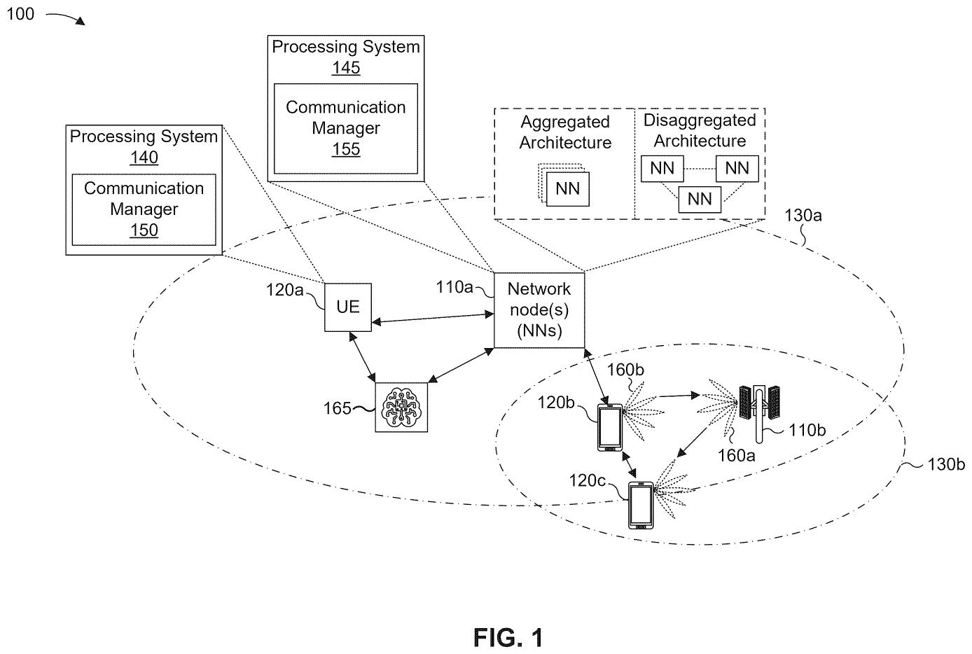

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR 1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

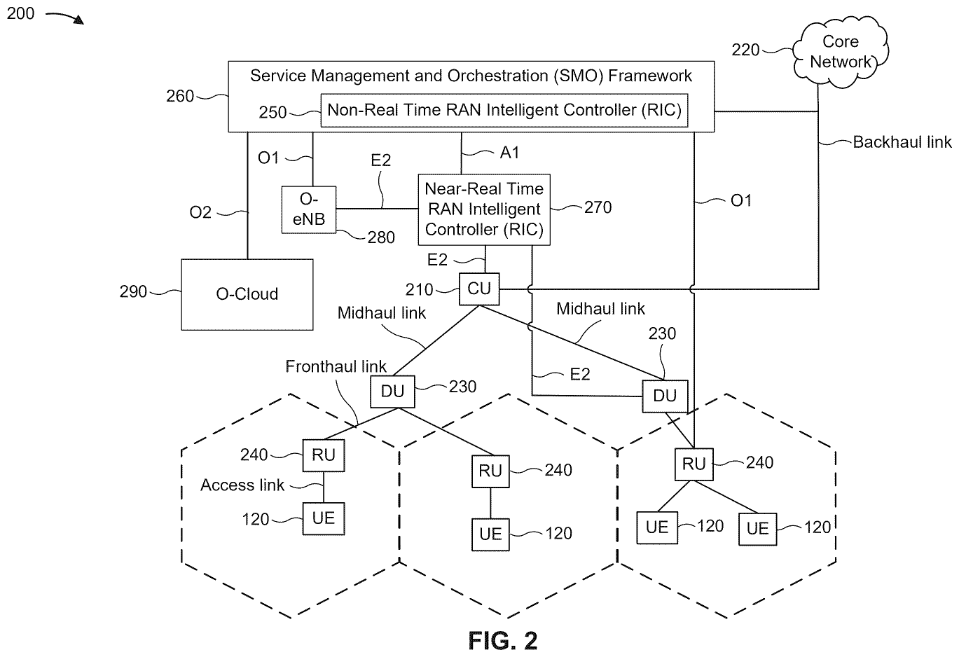

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as an RRC layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a DCI configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, one or more network nodes 110, one or more UEs 120, and/or one or more servers, and/or one or more components of a cloud computing network, among other examples). For example, in an deployment where AI/ML functionality is performed independently at a device 165, sometimes referred to as “overlay AI/ML”, the AI/ML model (or an instance or portion of the AI/ML model) may be deployed at a UE 120 (for example, at the processing system 140), a network node 110 (for example, at the processing system 145), one or more servers, and/or one or more components of a cloud computing network, among other examples. Additionally or alternatively, in a deployment where AI/ML functionality is coordinated between different devices 165, sometimes referred to as “coordinated AI/ML”, or performed at all device and network layers, sometimes referred to as “native AI/ML”, the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML and/or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, and/or efficient use of network bandwidth, and/or to reduce latency, among other examples). For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases such as a self-organizing network (SON), minimization of drive test (MDT), quality of experience (QoE), positioning, sensing, predictive mobility, and/or traffic prediction, among other examples. In some examples, AI-as-a-Service use cases may include measurement collection reporting by a UE 120, device selection criteria (for example, according to a geographical area where measurements are to be collected and/or UE capabilities to be used to collected measurements), and/or reporting configurations (for example, reporting parameters such as location, time, and/or sensor information, among other examples). Additionally or alternatively, the AI/ML model(s) may enable AI/ML procedures (for example, RAN-triggered service establishment, configuration, inferencing using UE-side and/or network-side models, performance monitoring and/or management, and/or capability signaling, among other examples). Additionally or alternatively, the AI/ML model(s) may enable RAN-based AI/ML services via one or more application program interfaces (APIs) and/or management interfaces for use cases such as beam management, radio resource monitoring (RRM) relaxation, mobility prediction, load prediction, network energy savings, and/or coverage and capacity improvements, among other examples).

In some aspects, a UE (e.g., a UE 120) may include a communication manager 150. As described in more detail elsewhere herein, the communication manager 150 may receive an indication of one or more scheduling configurations, and receive a WUS that indicates selection of a specific scheduling configuration of the one or more scheduling configurations. Additionally, or alternatively, the communication manager 150 may perform one or more other operations described herein.

In some aspects, a network node (e.g., a network node 110) may include a communication manager 155. As described in more detail elsewhere herein, the communication manager 155 may transmit an indication of one or more scheduling configurations, and transmit a WUS that indicates selection of a specific scheduling configuration in the one or more scheduling configurations. Additionally, or alternatively, the communication manager 155 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

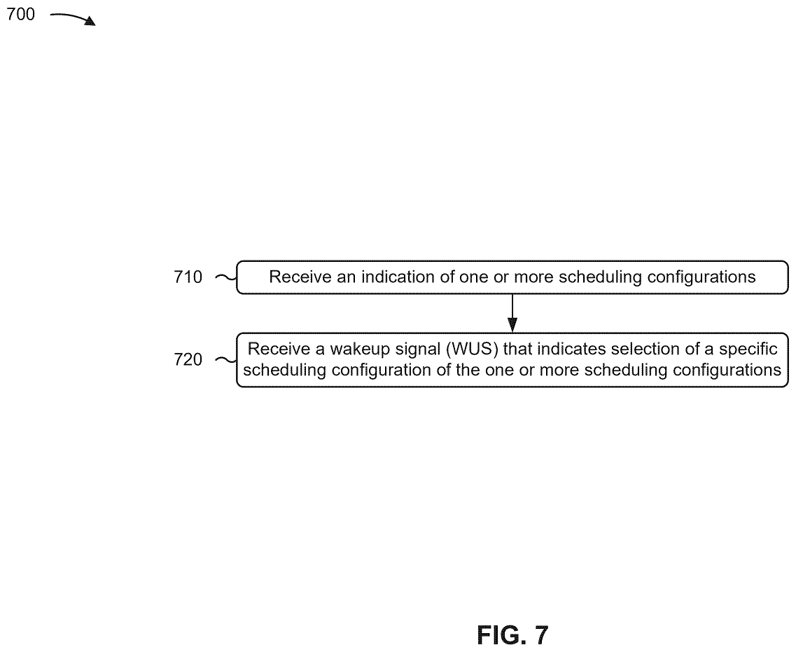

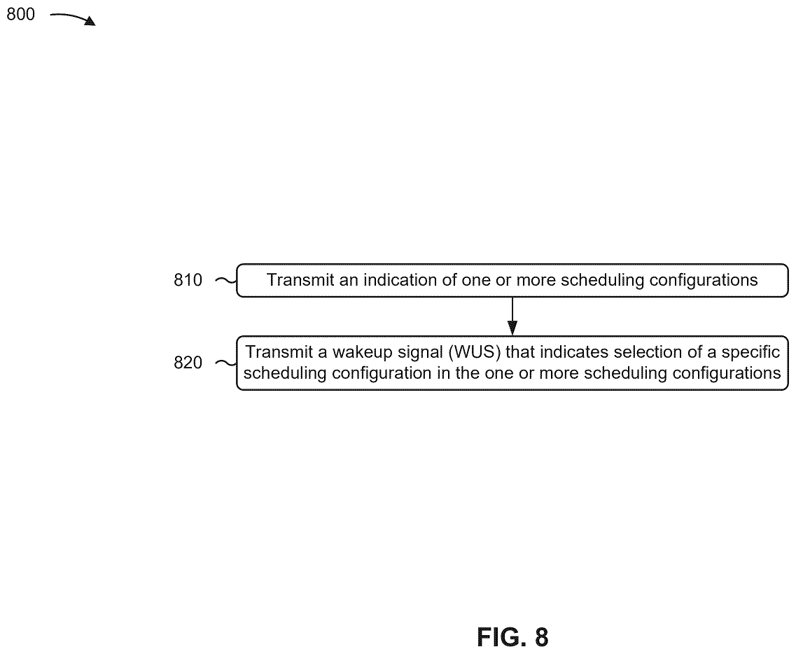

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with a wakeup signal that indicates a scheduling configuration, as described in more detail elsewhere herein. For example, the processing system 145 of the network node 110, the processing system 140 of the UE 120, the CU 210, the DU 230, or the RU 240 may perform or direct operations of, for example, process 700 of FIG. 7, process 800 of FIG. 8, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 700 of FIG. 7, process 800 of FIG. 8, or other processes as described herein. In some examples, executing instructions may include running the instructions, converting the instructions, compiling the instructions, and/or interpreting the instructions, among other examples.

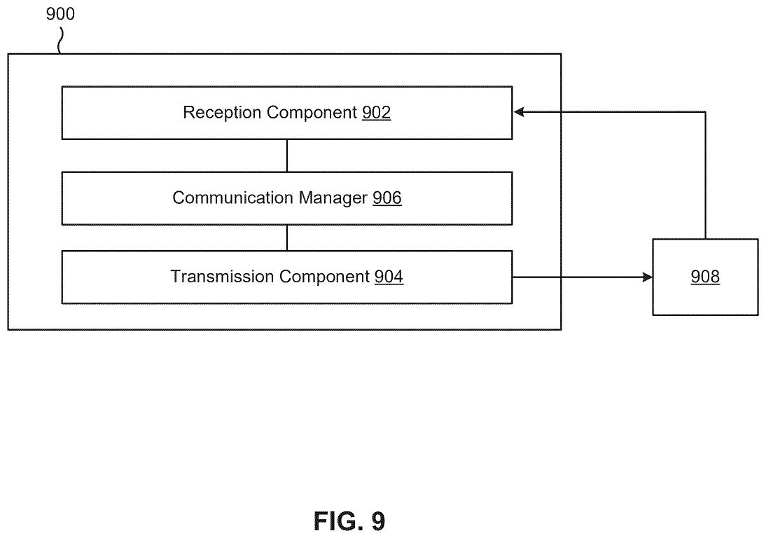

In some aspects, a UE (e.g., a UE 120) includes means for receiving an indication of one or more scheduling configurations; and/or means for receiving a WUS that indicates selection of a specific scheduling configuration of the one or more scheduling configurations. The means for the UE to perform operations described herein may include, for example, one or more of communication manager 150, processing system 140, a radio, one or more RF chains, one or more transceivers, one or more antennas, one or more modems, a reception component (for example, reception component 902 depicted and described in connection with FIG. 9), and/or a transmission component (for example, transmission component 904 depicted and described in connection with FIG. 9), among other examples.

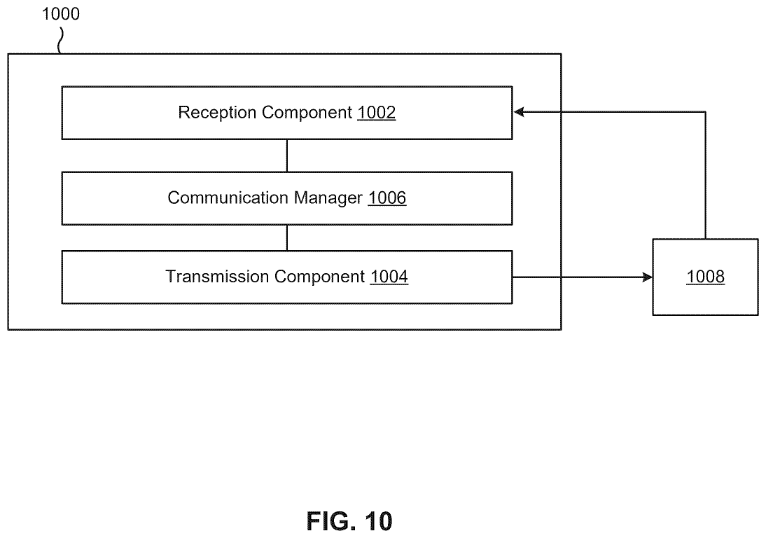

In some aspects, a network node (e.g., a network node 110) includes means for transmitting an indication of one or more scheduling configurations; and/or means for transmitting a WUS that indicates selection of a specific scheduling configuration in the one or more scheduling configurations. The means for the network node to perform operations described herein may include, for example, one or more of communication manager 155, processing system 145, a radio, one or more RF chains, one or more transceivers, one or more antennas, one or more modems, a reception component (for example, reception component 1002 depicted and described in connection with FIG. 10), and/or a transmission component (for example, transmission component 1004 depicted and described in connection with FIG. 10), among other examples.

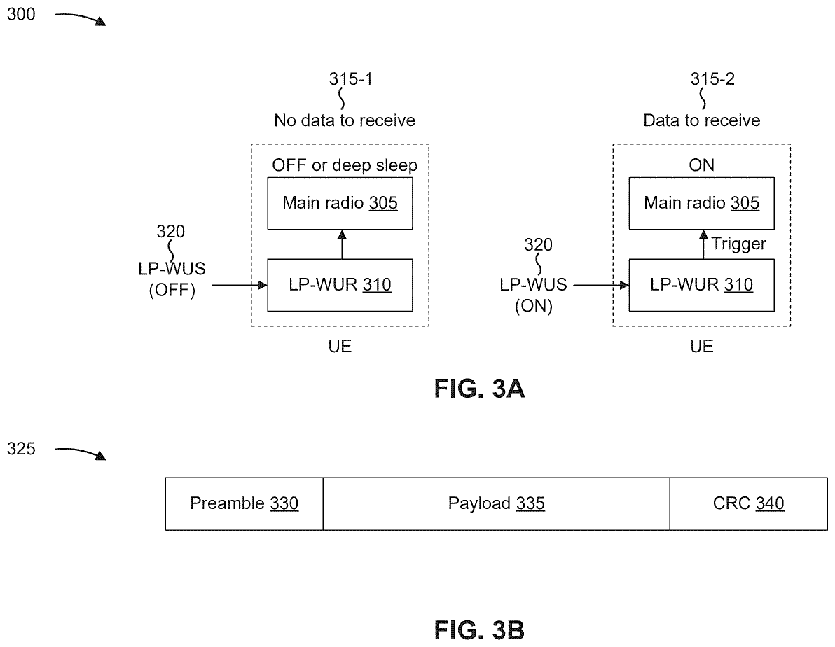

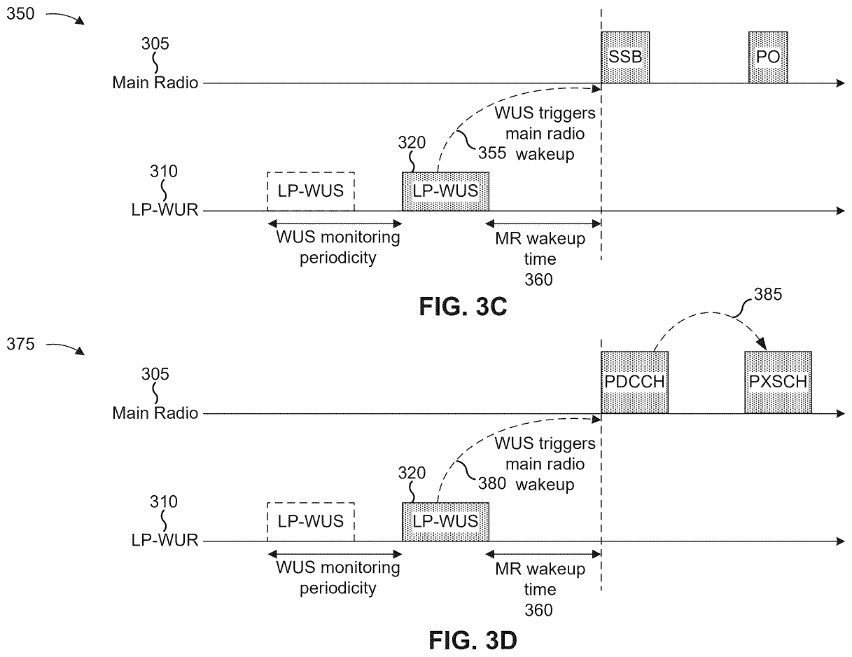

FIGS. 3A, 3B, 3C, and 3D are diagrams illustrating, respectively, a first example 300 of an LP-WUR, a second example 325 of a low power wakeup signal (LP-WUS), a third example 350 of a first LP-WUS procedure, and a fourth example 375 of a second LP-WUS procedure, in accordance with the present disclosure. As shown in FIG. 3A, a UE (such as UE 120) may be equipped with a communication system that includes a main radio (illustrated as “MR”) 305 and an LP-WUR 310 to reduce power consumption and enable low latency. For example, power saving and low latency are often conflicting goals because placing one or more components into a sleep state more often to reduce power consumption also increases latency (e.g., because data cannot be transmitted and/or received while the one or more components are in the sleep state), and because reducing the time that one or more components spend in a sleep state to reduce latency can lead to increased power consumption. Accordingly, as shown in FIG. 3A, the UE may be equipped with the LP-WUR 310, which may be considered a companion receiver that can be used with a main radio 305 to reduce power consumption and latency.

For example, in some aspects, the UE may generally use the main radio 305 to transmit and/or receive user data, and the main radio 305 may be turned off or operated in a deep sleep state unless there is user data to transmit and/or receive. Furthermore, the LP-WUR 310 may serve as a simple wakeup receiver for the main radio 305, and the LP-WUR 310 may be active and monitoring for an LP-WUS while the main radio 305 is off or in the deep sleep state. For example, reference number 315-1 depicts a first state associated with the main radio 305 and the LP-WUR 310 where there is no user data to be provided to the main radio 305. In such cases, the main radio 305 may be off or operated in the deep sleep state unless there is user data to transmit, and the LP-WUR 310 may monitor for an LP-WUS (for example, continuously, or periodically in monitoring occasions that are separated in time). Furthermore, reference number 315-2 depicts a second state associated with the main radio 305 and the LP-WUR 310 where there is user data for the main radio 305. In such cases, the LP-WUR 310 may receive an LP-WUS 320 (such as from a network node 110) and may provide a trigger to wake or otherwise activate the main radio 305 based on detecting the LP-WUS 320. Accordingly, the main radio 305 may then transmit and/or receive user data.

In general, the LP-WUR 310 may consume very little power (for example a target power consumption less than 100 microwatts (μW) in the active state), which may be achieved using simple modulation schemes (for example, on-off keying (OOK)), a narrow bandwidth (for example, less than 5 MHz), and/or other suitable techniques. In this way, the LP-WUR 310 can be used to reduce the time that the main radio 305 spends in an on state and/or may avoid unnecessarily waking the main radio 305 from the off or deep sleep state when there is no user data to transmit or receive, which tends to be costly from a power consumption perspective. Furthermore, because the LP-WUR 310 has a very low power consumption, the LP-WUR 310 can be used to frequently or continuously perform LP-WUS monitoring, which may improve latency because the main radio 305 can be woken up when there is user data that the main radio 305 needs to receive. For example, the LP-WUR 310 may not suffer from the latency versus power efficiency tradeoff associated with duty cycling schemes, such as DRX. Furthermore, in addition to performing LP-WUS monitoring, which may be used for paging reception, the LP-WUR 310 may monitor a low power synchronization signal (LP-SS) for time and frequency tracking and radio resource management (RRM) measurement. In this way, by monitoring the LP-SS, serving cell and/or neighbor cell monitoring can be offloaded from the main radio 305 to the LP-WUR 310 to reduce how often the main radio 305 is woken up, which can further reduce power consumption.

In some aspects, the LP-WUR 310 may include an OOK WUR (also referred to as an envelope detector (ED) WUR). An OOK WUR may only detect the amplitude (such as the magnitude) of a received signal. A UE that uses an OOK WUR may detect the phase of a received signal by activating the main radio 305.

In some aspects, the LP-WUR 310 may include an OFDM WUR (which may be referred to as an in-phase and quadrature (IQ) WUR). An OFDM WUR can detect both the amplitude and phase of a received signal. For example, an OFDM WUR can obtain first information that is modulated onto a signal using OOK modulation, and second information that is modulated onto the signal using phase modulation.

The second example 325 shown by FIG. 3B is an example LP-WUS that may be transmitted by a network node 110 and/or received by a UE 120 as described herein. In some aspects, the network node 110 may transmit the LP-WUS shown by the second example 325 in one or more air interface resources of a resource pool that is dedicated to a LP-WUS (e.g., an RRC configured resource pool that is dedicated to a LP-WUS). As one example, the resource pool may be based at least in part on a paging search space. Alternatively, or additionally, the UE 120 may receive the LP-WUS using an LP-WUR (e.g., the LP-WUR 310) that consumes less power relative to a main radio (e.g., the main radio 305). For instance, a network node may modulate an LP-WUS (e.g., the LP-WUS 320) using a simplified modulation scheme (e.g., relative to OFDM), such as binary phase shift keying (BPSK) and/or amplitude shift keying (ASK), that enables a UE to implement and/or use an LP-WUR (e.g., the LP-WUR 310) that consumes less power relative to the main radio. One example ASK modulation scheme is OOK.

An LP-WUS may be partitioned into multiple sections and/or fields, and each section and/or field may carry different information. For instance, the LP-WUS shown by the second example 325 includes a preamble field 330, a payload field 335, and a cyclic redundancy check (CRC) field 340. The preamble field 330 may be configured with a fixed pattern and/or a pre-configured pattern of data (e.g., a fixed pattern of bits and/or a pre-configured pattern of bits), such as “10101010” or “11001100.” The inclusion of the preamble field 330 in the LP-WUS may enable a receiving device (e.g., a UE 120) to identify a presence of an LP-WUS and/or to synchronize to an incoming bit stream included in the LP-WUS, such as the payload field 335 and/or the CRC field 340. The payload field 335 may include one or more sub-fields, and each sub-field may be configured to carry respective information. For instance, the payload field 335 may include an identifier field that indicates an intended recipient of the LP-WUS. The CRC field 340 may enable a receiving device to detect whether the received data includes errors or not.

The third example 350 shown by FIG. 3C is a first example LP-WUS procedure that uses the LP-WUR 310. In some aspects, the first example LP-WUS procedure is associated with a UE operating in an idle mode or an inactive mode (e.g., an RRC idle mode or an RRC inactive mode). In the first application, the LP-WUR 310 monitors for the LP-WUS 320. Based at least in part on the UE operating in the idle mode and/or the inactive mode, receipt of the LP-WUS may indicate to monitor a paging occasion. In such a scenario, the LP-WUS may be used to reduce unnecessary paging reception performed by the main radio 305 and, consequently, conserve power. For example, as shown in FIG. 3C, the LP-WUR 310 may be configured to monitor for an LP-WUS 320 (while the main radio 305 is off or in a deep sleep state) according to a WUS monitoring periodicity. That is, the LP-WUR 310 may monitor for the LP-WUS 320 in periodic LP-WUS monitoring occasions that are spaced in time according to the WUS monitoring periodicity. Alternatively, although not explicitly shown in FIG. 3C, the LP-WUR 310 may be configured to continuously monitor for the LP-WUS 320. In general, a network node may transmit an LP-WUS 320 to a UE only in cases where there is a paging message that needs to be sent to the UE while the UE is in the idle mode or the inactive mode. In such cases, the LP-WUR 310 may receive and detect the LP-WUS 320, and, as shown by reference number 355, may trigger the LP-WUR 310 to wake up the main radio 305. In some aspects, the LP-WUS 320 may be a sequence-based WUS, which may include a predefined set of sequences (implemented, for example, using OOK modulation and/or phase modulation).

As shown by reference number 360, the main radio 305 may wake up after a main radio wakeup time, and may then start to monitor one or more synchronization signal block (SSB) transmissions to obtain synchronization with the network node before monitoring and receiving the paging message in a subsequent PO. In cases where the LP-WUR 310 does not detect the LP-WUS 320, the main radio 305 may remain in the deep sleep state to save power. Example wakeup times may include 12 milliseconds (msec) for a transition out of a light sleep mode and 15 msec for a transition out of a deep sleep mode. Example power consumption by the main radio 305 may include 62 milliamps (mA) while processing a PDCCH with a 20 MHz bandwidth and 2 communication layers, 145 mA for a PUSCH transmission that has a 20 MHz bandwidth, and 1.4 mA while operating in a deep sleep mode.

The fourth example 375 shown by FIG. 3D is a second application of the LP-WUR 310 that is associated with a UE operating in a connected mode (e.g., an RRC connected mode). In a similar manner as the first application described with regard to FIG. 3C, the LP-WUR 310 monitors for the LP-WUS 320. Based at least in part on the UE operating in a connected mode, receipt of the LP-WUS 320 may indicate to monitor a control channel (e.g., a PDCCH) for scheduling information. The use of the LP-WUS 320 for a UE operating in a connected mode may reduce a number of times that the UE operates in an active mode of an associated discontinuous reception (DRX) cycle, which can be used to reduce unnecessary reception performed by the main radio 305. For example, in a similar manner as described with regard to FIG. 3C, the LP-WUR 310 may be configured to monitor for the LP-WUS 320 (while the main radio 305 is off or in a deep sleep state) according to the WUS monitoring periodicity. A network node may transmit an LP-WUS 320 to a UE in scenarios where there is a (pending) control channel message for the UE. In such cases, the network node may transmit the LP-WUS 320, which may be received and detected by the LP-WUR 310. As shown by reference number 380, reception and detection of the LP-WUS 320 may trigger the LP-WUR 310 to wake up the main radio 305. As shown by FIG. 3D, the main radio 305 may wake up after the main radio wakeup time, and may then start to monitor one or more PDCCH monitoring occasions (PMOs). Otherwise, in cases where the LP-WUR 310 does not detect the LP-WUS 320, the main radio 305 may remain in the deep sleep state to save power. In some aspects, the UE may receive scheduling information in PDCCH that occurs during a PMO, and the PDCCH may include scheduling information for a PDSCH transmission as shown by reference number 385.

As indicated above, FIGS. 3A, 3B, 3C, and 3D are provided as examples. Other examples may differ from what is described with regard to FIGS. 3A, 3B, 3C, and 3D.

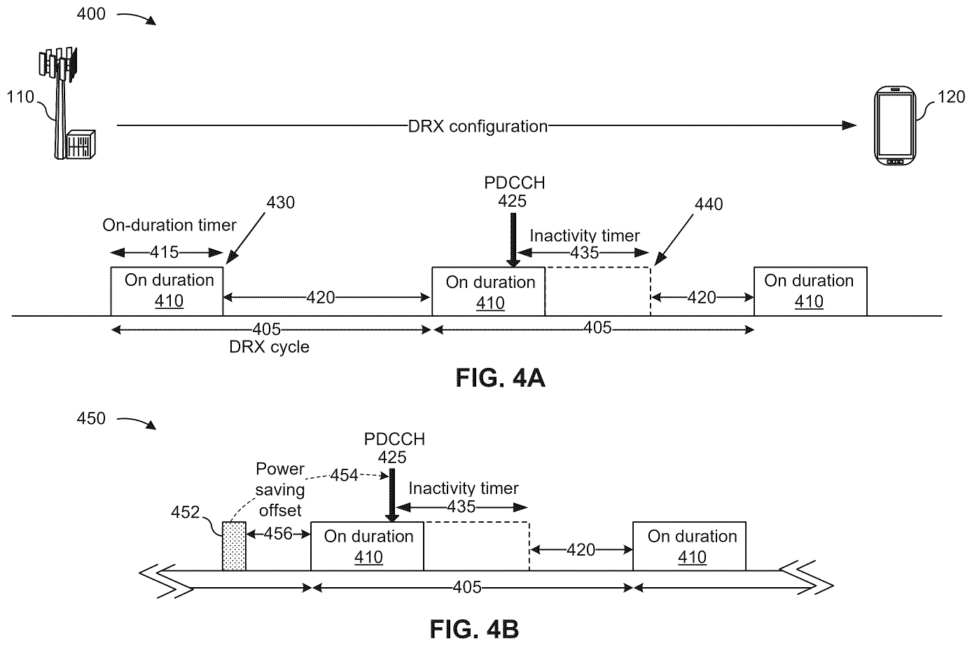

FIGS. 4A and 4B are diagrams illustrating a first example 400 and a second example 450 of discontinuous reception (DRX), in accordance with the present disclosure.

In the first example 400 shown by FIG. 4A, a network node 110 may transmit a DRX configuration to a UE 120 to configure a DRX cycle 405 for the UE 120. A DRX cycle 405 may include a DRX on duration 410 (e.g., during which a UE 120 is awake or in an active state) and an opportunity to enter a DRX sleep state 420. As used herein, the time during which the UE 120 is configured to be in an active state during the DRX on duration 410 may be referred to as an active time, and the time during which the UE 120 is configured to be in the DRX sleep state 420 may be referred to as an inactive time. As described below, the UE 120 may monitor a PDCCH during the active time, and may refrain from monitoring the PDCCH during the inactive time. In some aspects, the DRX on duration 410 may be based at least in part on an on-duration timer 415. Alternatively, or additionally, the DRX on duration 410 may begin after an offset that is relative to a start of a time partition. For example, the DRX on duration 410 may begin after a slot offset that is relative to a start of a time slot.

During the DRX on duration 410 (e.g., the active time), the UE 120 may monitor a downlink control channel (e.g., a PDCCH), as shown by reference number 425. For example, the UE 120 may monitor the PDCCH for DCI pertaining to the UE 120. If the UE 120 does not detect and/or successfully decode any PDCCH communications intended for the UE 120 during the DRX on duration 410, then the UE 120 may enter the sleep state 420 (e.g., for the inactive time) at the end of the DRX on duration 410, as shown by reference number 430. In this way, the UE 120 may conserve battery power and reduce power consumption. As shown, the DRX cycle 405 may repeat with a configured periodicity according to the DRX configuration.

If the UE 120 detects and/or successfully decodes a PDCCH communication intended for the UE 120, then the UE 120 may remain in an active state (e.g., awake) for the duration of a DRX inactivity timer 435 (e.g., which may extend the active time). The UE 120 may start the DRX inactivity timer 435 at a time at which the PDCCH communication is received (e.g., in a transmission time interval (TTI) in which the PDCCH communication is received, such as a slot or a subframe). The UE 120 may remain in the active state until the DRX inactivity timer 435 expires, at which time the UE 120 may enter the sleep state 420 (e.g., for the inactive time), as shown by reference number 440. During the duration of the DRX inactivity timer 435, the UE 120 may continue to monitor for PDCCH communications, may obtain a downlink data communication (e.g., on a downlink data channel, such as a PDSCH) scheduled by the PDCCH communication, and/or may prepare and/or transmit an uplink communication (e.g., on a PUSCH) scheduled by the PDCCH communication. The UE 120 may restart the DRX inactivity timer 435 after each detection of a PDCCH communication for the UE 120 for an initial transmission (e.g., but not for a retransmission). By operating in this manner, the UE 120 may conserve battery power and reduce power consumption by entering the sleep state 420.

The second example 450 shown by FIG. 4B is an example of C-DRX that is configured with DCP as a WUS to decrease power consumption by a UE 120 and/or increase power savings at the UE 120. That is, the C-DRX cycle may use a DCP as a wakeup signal. As an example, a network node 110 may transmit a DCP to a UE 120 that is operating in a C-DRX mode to indicate whether to start an on-duration timer for an associated DRX cycle (e.g., and transition to an active state) and/or whether to remain in a sleep state.

To illustrate, in a similar manner as described with regard to FIG. 4A, a network node 110 may transmit a DRX configuration to a UE 120 that configures C-DRX operation at the UE 120, such as by configuring any combination of a DRX cycle used by the UE 120 (e.g., the DRX cycle 405), a DRX on duration (e.g., the DRX on duration 410), and/or a DRX sleep state (e.g., the DRX sleep state 420). In some aspects, the DRX configuration may indicate a DCP state, such as an enabled DCP state that indicates that the C-DRX mode uses DCP signaling and/or a disabled DCP state that indicates that the C-DRX mode does not use DCP signaling.

Based at least in part on operating in a C-DRX mode, the UE 120 may monitor PDCCH that is associated with a serving cell (e.g., the network node 110) during an active time (e.g., the DRX on duration 410) and may operate in a sleep state outside of the active time in a similar manner as described with regard to FIG. 4A. The active time may be based at least in part on an on-duration timer (e.g., the on-duration timer 415) and/or an inactivity timer (e.g., the inactivity timer 435). In some cases, the UE 120 may remain in a sleep state instead of transitioning to an active state for the on duration 410 based at least in part on the C-DRX mode being configured with an enabled DCP state.

For example, the network node 110 may transmit a DCP 452 (shown with a dotted pattern) as a wakeup signal that indicates whether the UE 120 should monitor for PDCCH during the DRX on duration 410 as shown by reference number 454, or whether to remain in a sleep state. In some cases, the network node 110 may transmit the DCP 452 using a power saving offset 456 that may be based at least in part on a start of a search time for the DCP 452 and a start of the DRX on duration 410. Example values for the power saving offset 456 may include multiples of 0.125 milliseconds (msec), such as 0.125 msec, 0.25 msec, and/or 0.375 msec. Based at least in part on the DCP 452 being carried in PDCCH, the UE 120 may use a main radio (e.g., the main radio 305) to receive and decode the DCP 452. Relative to monitoring PDCCH in the DRX on duration 410, the UE 120 may consume less power via the main radio to receive and decode the DCP 452. Accordingly, a DCP 452 that indicates to remain in a sleep state may enable the UE 120 keep the main radio in a sleep state during the DRX on duration 410 and, consequently, reduce power consumption.

As indicated above, FIGS. 4A and 4B are provided as examples. Other examples may differ from what is described with respect to FIGS. 4A and 4B.

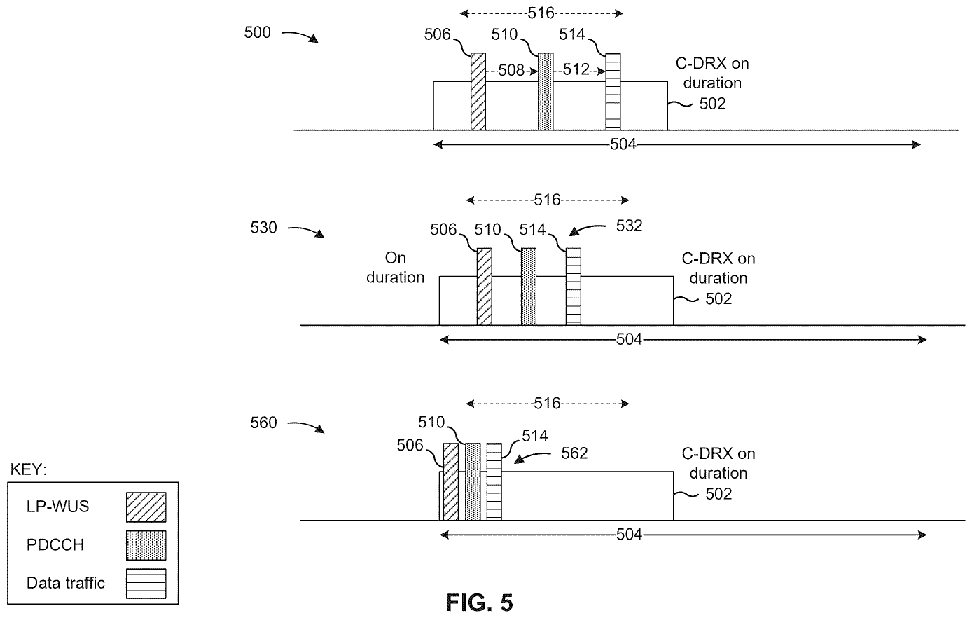

FIG. 5 is a diagram illustrating a first example 500, a second example 530, and a third example 560 of an LP-WUS that may be used in a C-DRX mode, in accordance with the present disclosure.

An alternative to using a DCP as a wakeup signal for a UE (e.g., a UE 120) operating in a C-DRX mode is an LP-WUS as described with regard to FIGS. 3A-3D. A UE may use an LP-WUR to monitor for the LP-WUS such that the UE may transition a main radio to a sleep state to reduce power consumption and/or increase power saving relative to monitoring for a DCP via the main radio. To illustrate, a network node (e.g., a network node 110) may transmit an LP-WUS to instruct a UE that is operating in a C-DRX mode to initiate PDCCH monitoring via a main radio. The network node may transmit, and the UE may monitor for, the LP-WUS using a variety of timing configurations. As a first timing configuration, LP-WUS transmission and/or LP-WUS monitoring may occur prior to a DRX on duration in a similar manner as the DCP 452 described with regard to FIG. 4B. As a second timing configuration, LP-WUS transmission and/or LP-WUS monitoring may occur outside of at least a C-DRX active time and/or a C-DRX on duration based at least in part on an LP-WUS monitoring configuration that is associated with the LP-WUS triggering PDCCH monitoring. For instance, PDCCH monitoring may be independent of a DRX on duration time such that LP-WUS transmission and/or LP-WUS monitoring are also independent of the DRX on duration time, and/or use the LP-WUS monitoring configuration. In other examples, triggering PDCCH monitoring via an LP-WUS may be based on a DRX on duration (e.g., prior to the DRX on duration, in a similar manner as described with regard to the first timing configuration).

A third timing configuration may be based at least in part on LP-WUS transmission and/or LP-WUS monitoring occurring within a C-DRX active time and/or within a C-DRX on duration, where the LP-WUS transmission and/or the LP-WUS monitoring may be based at least in part on an LP-WUS monitoring configuration (e.g., that is associated with the LP-WUS triggering PDCCH monitoring). To illustrate, the first example 500 includes a C-DRX on duration 502 that is associated with a UE (e.g., a UE 120) operating in a C-DRX mode. The C-DRX on duration 502 occurs within a DRX cycle 504 in a similar manner as described with regard to FIGS. 4A and 4B. As part of operating in an enhanced power saving mode that increases power savings, relative to operating in the C-DRX mode without the enhanced power saving mode, the UE may not transition a main radio out of a sleep state for the C-DRX on duration 502. Instead, and as part of the enhanced power saving mode, the UE may monitor for an LP-WUS using an LP-WUR.

In the third timing configuration, the network node may transmit, and the UE may receive, an LP-WUS 506 (shown with diagonal stripes) within the C-DRX on duration 502. As shown by reference number 508, the LP-WUS 506 may indicate to transition the main radio out of the sleep state to monitor for a PDCCH 510 (shown with a dotted pattern). Accordingly, the UE may transition the main radio from a sleep state to an active state in sufficient time to receive the PDCCH 510. As shown by reference number 512, the PDCCH 510 may include scheduling information for data traffic 514 (shown with horizontal stripes). The scheduling information for data traffic 514 may include downlink scheduling information for downlink data traffic and/or uplink scheduling information for uplink data traffic.

Some data traffic transmissions may be based in part on a frame rate. To illustrate, XR may include virtual reality and/or augmented reality in which a server renders video images at a frame rate (e.g., 60 frames per second (fps)), and the video images may be transmitted, by way of a network node, as respective image frames in downlink data traffic to a UE. A UE operating in a C-DRX mode may receive each image frame based at least in part on receiving an LP-WUS (e.g., the LP-WUS 506) using an LP-WUR, transitioning a main radio to an active state to receive PDCCH (e.g., the PDCCH 510) that indicates scheduling information for the image frame, and receiving the image frame as downlink data traffic (e.g., the data traffic 514). The UE may transition back to a sleep state after receipt of the downlink data traffic.

Although a server may generate the image frames at a periodic rate on average, the transmission of the image frames may be subject to jitter 516 that is a deviation from an expected periodicity. For instance, variations in network congestion, signal interference, and/or UE mobility may change an amount of jitter observed at the UE such that a reception time of the data traffic 514 may vary within the C-DRX on duration 502, as shown in FIG. 5 with regard to the second example 530 and the third example 560. To mitigate the effects of the jitter 516, a network node may configure the C-DRX on duration 502 to a value that matches a frame rate that is associated with the image frames, such as by increasing a duration of the C-DRX on duration 502 and/or configuring a periodicity of the C-DRX on durations based at least in part on the frame rate. Increasing a duration of the C-DRX on duration 502 may increase an amount of time that a UE operates in the active mode and, consequently, may increase an amount of power consumed by the UE. The use of an LP-WUS, such as the LP-WUS 506 shown in FIG. 5 in the first example 500, may mitigate increased power consumption by the UE due to an increased C-DRX on duration by enabling the UE to remain in a sleep state for longer durations.

Some forms of data traffic, such as XR data traffic, may be delay sensitive and/or may be less tolerant to reception outside of a particular time window. For instance, data traffic that is received outside of the particular time window may be useless and/or discarded. As one example, data traffic in the form of an XR image frame may be associated with a 10 msec time window and reception of the XR image frame outside of the 10 msec time window may render the XR image frame useless. Although an LP-WUS may decrease power consumption and/or increase power savings at a UE, the use of the LP-WUS may also add time to receiving data traffic, resulting in an image frame carried in data traffic becoming invalid and/or useless, and/or may lead to the image frame being discarded.

For instance, as described with regard to the first example 500, a UE first receives the LP-WUS 506 that indicates to wake up a main radio, and the LP-WUS 506 is followed by the PDCCH 510 that indicates scheduling information, such as a coding rate, a modulation and coding scheme (MCS), and/or air interface resource(s), that the UE uses to receive and recover the data traffic 514. In some cases, transitioning a main radio to an active state may cause delay to when the UE may successfully receive and decode the PDCCH, such as a 2 msec delay. The added delay, in combination with jitter (e.g., the jitter 516), may result in the UE failing to receive PDCCH and, consequently, scheduling information that enables the UE to receive the data traffic. For instance, the second example 530 includes a first scenario 532 in which the LP-WUS 506, the PDCCH 510, and the data traffic 514 are received in a shorter time interval relative to the first example 500 based at least in part on an effect of jitter 516 on the data traffic 514. Similarly, the third example 560 includes a second scenario 562 in which the LP-WUS 506, the PDCCH 510, and the data traffic 514 are received in a shorter time interval relative to the first example 500 and the second example 530 based at least in part on an effect of jitter 516 on the data traffic 514. The shorter time intervals of the first scenario 532 and the second scenario 562 may result in the UE failing to receive the data traffic 514 based at least in part on failing to receive the PDCCH 510 due to the main radio transition time being longer than a time interval to reception of the data traffic 514.

Various aspects relate generally to a wakeup signal that indicates a scheduling configuration, such as a reception scheduling configuration, a transmission scheduling configuration, a downlink scheduling configuration, and/or an uplink scheduling configuration. Some aspects more specifically relate to a network node indicating selection of a preconfigured scheduling configuration in the wakeup signal. In some aspects, a UE may receive an indication of one or more scheduling configurations, such as one or more downlink scheduling configurations and/or one or more uplink scheduling configurations. Other examples may include reception scheduling configurations and/or transmission scheduling configurations associated with a sidelink. For instance, the UE may receive an indication of a table that includes multiple scheduling configurations, and each scheduling configuration may include one or more parameters, such as an MCS parameter, a coding rate parameter, and an air interface resource parameter that are set to respective values and/or different combinations of values. Alternatively, or additionally, each scheduling configuration may be associated with a respective index of the table. Based at least in part on receiving the indication of the scheduling configuration(s), the UE may receive a WUS that indicates selection of a specific scheduling configuration of the multiple scheduling configuration(s). For instance, the UE may operate in a C-DRX mode and may receive, as the WUS, an LP-WUS. In some aspects, the LP-WUS may indicate the selection of the specific scheduling configuration, such as a specific downlink scheduling configuration that is associated with a downlink data traffic transmission (e.g., a PDSCH transmission), and the UE may receive the downlink data traffic transmission using the downlink scheduling configuration. In other aspects, the specific scheduling configuration may indicate an uplink scheduling configuration that is associated with an uplink data traffic transmission (e.g., a physical uplink shared channel (PUSCH) transmission), and the UE may transmit the uplink data traffic transmission using the uplink scheduling configuration.

In some aspects, a network node may transmit an indication of one or more scheduling configurations. For instance, as part of establishing a connection with a UE, the network node may transmit the indication of the scheduling configuration(s) in RRC signaling. Based at least in part on transmitting the indication of the scheduling configuration(s), the network node may transmit a WUS that indicates selection of a specific scheduling configuration of the scheduling configuration(s). For instance, the specific scheduling configuration may indicate a specific downlink scheduling configuration that is associated with a downlink data traffic transmission (e.g., a PDSCH transmission), and the network node may transmit the downlink data traffic transmission using the specific downlink scheduling configuration. In other aspects, the specific scheduling configuration may indicate a specific uplink scheduling information that is associated with an uplink data traffic transmission (e.g., a PDSCH transmission), and the network node may receive the uplink data transmission using the specific uplink scheduling information.

Particular aspects of the subject matter described in this disclosure can be implemented to realize one or more of the following potential advantages. In some examples, by indicating a scheduling configuration in a WUS, the described techniques can be used to mitigate timing delays at a UE operating in a C-DRX mode and mitigate the UE missing a data traffic transmission. For example, the network node may indicate the scheduling configuration in the WUS and may not transmit a PDCCH that indicates the scheduling configuration and may transmit a PDSCH directly after the WUS. Alternatively, or additionally, the UE may not receive, and/or may skip reception of, the PDCCH. Instead, the UE may configure a transceiver based at least in part on the indicated scheduling information. Skipping reception of the PDCCH may reduce an amount of time used by the UE to receive scheduling information that enables the UE to receive a downlink data traffic transmission and, consequently, may mitigate the UE missing reception of the downlink data traffic transmission. While described with regard to a downlink scheduling configuration and a downlink data traffic transmission, other examples may alternatively, or additionally, include a WUS indicating an uplink scheduling configuration that is used by the UE for an uplink data traffic transmission, where the indication of the uplink scheduling configuration may be based at least in part on a table of multiple uplink scheduling configurations.

As indicated above, FIG. 5 is provided as an example. Other examples may differ from what is described with regard to FIG. 5.

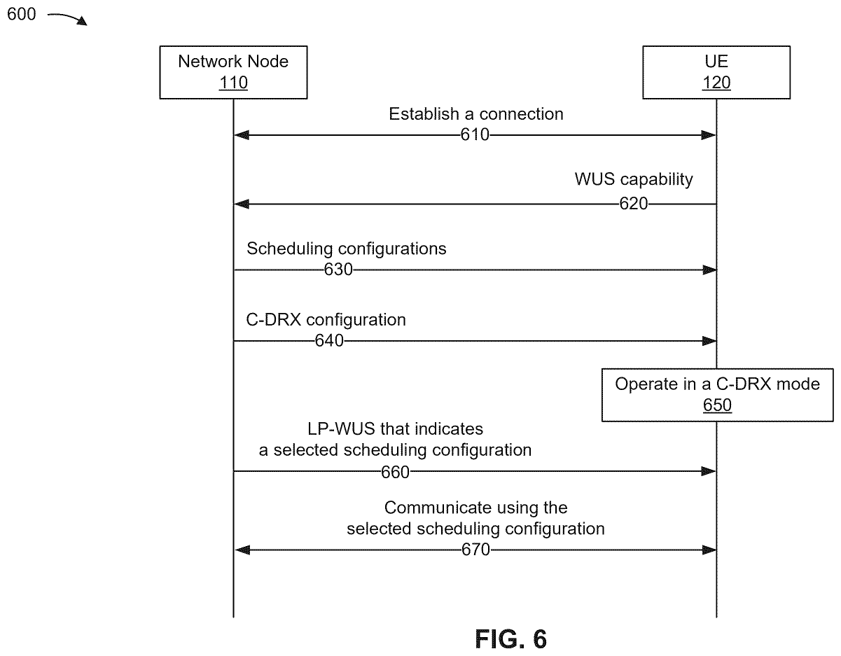

FIG. 6 is a diagram illustrating an example 600 of a wireless communication process between a network node (e.g., the network node 110) and a UE (e.g., the UE 120), in accordance with the present disclosure.

As shown by reference number 610, the network node 110 and the UE 120 may establish a connection. To illustrate, the UE 120 may power up in a cell coverage area provided by the network node 110, and the UE 120 and the network node 110 may perform one or more procedures (e.g., a random access channel (RACH) procedure and/or an RRC procedure) to establish a wireless connection. As another example, the UE 120 may move into the cell coverage area provided by the network node 110 and may perform a handover from a source network node (e.g., another network node 110) to the network node 110. Alternatively, or additionally, the network node 110 and the UE 120 may communicate via the connection based at least in part on any combination of Layer 1 signaling (e.g., DCI and/or uplink control information (UCI)), Layer 2 signaling (e.g., a MAC control element (CE)), and/or Layer 3 signaling (e.g., RRC signaling). To illustrate, the network node 110 may request, via RRC signaling, UE capability information and/or the UE 120 may transmit, via RRC signaling, the UE capability information. As part of communicating via the connection, the network node 110 may transmit configuration information via Layer 3 signaling (e.g., RRC signaling), and activate and/or deactivate a particular configuration via Layer 2 signaling (e.g., a MAC CE) and/or Layer 1 signaling (e.g., DCI). To illustrate, the network node 110 may transmit the configuration information via Layer 3 signaling at a first point in time associated with the UE 120 being tolerant of communication delays, and the network node 110 may transmit an activation of the configuration via Layer 2 signaling and/or Layer 1 signaling at a second point in time associated with the UE being less tolerant to communication delays.

As shown by reference number 620, the UE 120 may transmit, and the network node 110 may receive, an indication of a WUS capability. To illustrate, the UE 120 may transmit an indication that the UE 120 supports and/or includes a capability to receive an LP-WUS (e.g., an LP-WUS capability). Alternatively, or additionally, the UE 120 may transmit an indication that the UE 120 supports and/or includes a capability to receive a WUS (e.g., an LP-WUS) that indicates a scheduling configuration and/or selection of a specific scheduling configuration from multiple scheduling configurations.

For clarity, FIG. 6 illustrates the UE 120 transmitting the indication of the WUS capability in a separate transaction than establishing a connection with the network node 110. However, in some aspects, the UE 120 may transmit the indication of the WUS capability as part of establishing a connection with the network node 110.

As shown by reference number 630, the network node 110 may transmit, and the UE 120 may receive, an indication of one or more scheduling configurations. As one example, the network node 110 may transmit a table that includes one or more scheduling configurations, such as by transmitting the table and/or entries in the table using RRC signaling. Each scheduling configuration may be associated with a respective index (e.g., a table entry index) and/or a respective identifier (ID). The network node 110 may transmit, as the scheduling configuration(s), any combination of one or more downlink scheduling configurations, one or more uplink scheduling configurations, one or more transmission scheduling configurations (e.g., for a sidelink transmission), and/or one or more reception scheduling configurations (e.g., for a sidelink reception).

Each scheduling configuration may include a respective set of scheduling parameters that indicate control information and/or configuration information for receiving, transmitting, decoding, and/or encoding a transmission, such as time and/or frequency location information, a coding rate, and/or a modulation and coding scheme (MCS). To illustrate, the set of scheduling parameters may include and/or indicate a time partition offset (e.g. a symbol offset), a first quantity of time partitions (e.g., a number of symbols and/or a duration of a transmission), a resource offset (e.g., an RB offset) that indicates a location of a transmission resource (e.g., a PDSCH resource or a PUSCH resource), a second quantity of resources (e.g., a quantity of RBs), an MCS, and/or a coding rate. In some aspects, the resource offset may be relative to a resource that is associated with receiving a WUS. Each scheduling configuration may be configured with respective combinations of values such that each scheduling configuration is configured with a unique combination of values within scheduling configuration(s) indicated by the network node 110.

As shown by reference number 640, the network node 110 may transmit, and the UE 120 may receive, a C-DRX configuration. To illustrate, the network node 110 may indicate any combination of a DRX cycle duration, a DRX on duration, and/or a DRX sleep state. In some aspects, the C-DRX configuration may indicate a DCP state, such as an enabled DCP state that indicates that the C-DRX mode uses DCP signaling, and/or a disabled DCP state that indicates the C-DRX mode does not use DCP signaling. Alternatively, or additionally, the C-DRX configuration may indicate an LP-WUS state, such as an enabled LP-WUS state that indicates that the C-DRX mode uses LP-WUS signaling and/or a disabled LP-WUS state that indicates the C-DRX mode does not use LP-WUS signaling. The C-DRX configuration may include a single WUS mode field that indicates that the C-DRX mode uses DCP signaling when set to a first value (e.g., “0”) and indicates that the C-DRX mode uses LP-WUS signaling when set to a second value (e.g., “1”). In some aspects, the C-DRX configuration may indicate a WUS configuration (e.g., an LP-WUS configuration), such as a first WUS configuration in which the WUS does not indicate a scheduling configuration and/or a second WUS configuration in which the WUS indicates a scheduling configuration.

As shown by reference number 650, the UE 120 may operate in a C-DRX mode. For instance, the UE 120 may operate in a C-DRX mode as described with regard to FIG. 4B. As part of operating in the C-DRX mode, the UE 120 may transition a main radio to a sleep state and/or may monitor for an LP-WUS using an LP-WUR, such as in an example in which the C-DRX configuration indicates an enabled LP-WUS state.

As shown by reference number 660, the network node 110 may transmit, and the UE 120 may receive, a WUS, and the WUS may indicate a specific scheduling configuration. To illustrate, the network node 110 may transmit an LP-WUS that includes a payload, and the payload may include a field that indicates an index of an entry in a table, such as a table that includes one or more scheduling configurations. Accordingly, the network node 110 may transmit an LP-WUS that indicates the specific scheduling configuration. In indicating the specific scheduling configuration, the network node 110 may indicate a downlink grant, an uplink grant, and/or a sidelink grant that is assigned to the UE 120.

In some aspects, based at least in part on transmitting a WUS that indicates a scheduling configuration for a future transmission (e.g., for a downlink transmission, an uplink transmission, and/or a sidelink transmission), the network node 110 may not transmit PDCCH that indicates scheduling information for the future transmission. Alternatively, or additionally, based at least in part on receiving the WUS that indicates scheduling configuration for the future transmission, the UE 120 may skip PDCCH monitoring for a PDCCH that indicates scheduling information for the future transmission. To illustrate, the UE 120 may transition a main radio to an active state and configure the main radio based at least in part on the specific scheduling configuration that is indicated by the WUS.

As shown by reference number 670, the network node 110 and the UE 120 may communicate based at least in part on the specific scheduling configuration that is indicated by the WUS. As one example, the specific scheduling configuration that is indicated by the WUS may indicate a downlink scheduling configuration, and the network node 110 may transmit, and the UE 120 may receive, a downlink communication (e.g., a PDSCH data traffic transmission) using the downlink scheduling configuration. As another example, the specific scheduling configuration that is indicated by the WUS may indicate an uplink scheduling configuration, and the UE 120 may transmit, and the network node 110 may receive, an uplink communication using the uplink scheduling configuration. Other examples may include the UE 120 transmitting and/or receiving a sidelink communication (e.g., a Mode 1 sidelink communication) using the specific scheduling configuration.

By indicating a scheduling configuration in a WUS, a network node may mitigate timing delays at a UE operating in a C-DRX mode and mitigate the UE missing a data traffic transmission. For example, the network node may indicate the scheduling configuration in the WUS and may not transmit a PDCCH that indicates the scheduling configuration. Alternatively, or additionally, the UE may not receive, and/or may skip reception of, the PDCCH. Instead, the UE may configure a transceiver based at least in part on the indicated scheduling information. Skipping reception of the PDCCH may reduce an amount of time used by the UE to receive scheduling information that enables the UE to receive a downlink data traffic transmission and, consequently, may mitigate the UE missing reception of the downlink data traffic transmission. While described with regard to a downlink scheduling configuration and a downlink data traffic transmission, other examples may alternatively, or additionally, include a WUS indicating an uplink scheduling configuration that is used by the UE for an uplink data traffic transmission, where the indication of the uplink scheduling configuration may be based at least in part on a table of multiple uplink scheduling configurations.

As indicated above, FIG. 6 is provided as an example. Other examples may differ from what is described with regard to FIG. 6.

FIG. 7 is a diagram illustrating an example process 700 performed, for example, at a UE or an apparatus of a UE, in accordance with the present disclosure. Example process 700 is an example where the apparatus or the UE (e.g., UE 120) performs operations associated with a wakeup signal that indicates a scheduling configuration.

As shown in FIG. 7, in some aspects, process 700 may include receiving an indication of one or more scheduling configurations (block 710). For example, the UE (e.g., using reception component 902 and/or communication manager 906, depicted in FIG. 9) may receive an indication of one or more scheduling configurations, as described above.

As further shown in FIG. 7, in some aspects, process 700 may include receiving a WUS that indicates selection of a specific scheduling configuration of the one or more scheduling configurations (block 720). For example, the UE (e.g., using reception component 902 and/or communication manager 906, depicted in FIG. 9) may receive a WUS that indicates selection of a specific scheduling configuration of the one or more scheduling configurations, as described above.

Process 700 may include additional aspects, such as any single aspect or any combination of aspects described below and/or in connection with one or more other processes described elsewhere herein.

In a first aspect, the specific scheduling configuration is a downlink scheduling configuration, and process 700 includes receiving a downlink communication using the downlink scheduling configuration.

In a second aspect, process 700 includes skipping physical downlink control channel monitoring that is associated with the WUS based at least in part on the WUS indicating the specific scheduling configuration.

In a third aspect, the specific scheduling configuration is an uplink scheduling configuration, and process 700 includes transmitting an uplink communication using the uplink scheduling configuration.

In a fourth aspect, receiving the indication of the one or more scheduling configurations includes receiving the indication of the one or more scheduling configurations in RRC signaling.

In a fifth aspect, each scheduling configuration of the one or more scheduling configurations indicates a respective set of scheduling parameters.

In a sixth aspect, the respective set of scheduling parameters includes at least one of a time partition offset, a first quantity of time partitions, a resource offset, a second quantity of resources, a modulation and coding scheme, or a coding rate.

In a seventh aspect, the time partition offset is a symbol offset.

In an eighth aspect, the resource offset is a resource block offset.

In a ninth aspect, the resource offset is relative to a resource that is associated with receiving the WUS.

In a tenth aspect, the indication is a first indication, and process 700 includes transmitting, prior to receiving the first indication of the one or more scheduling configurations, a second indication of a capability to receive the WUS that indicates the selection of the specific scheduling configuration of the one or more scheduling configurations.

In an eleventh aspect, receiving the indication of the one or more scheduling configurations includes receiving a table that indicates the one or more scheduling configurations, and the WUS indicates an index of an entry in the table that is associated with the specific scheduling configuration.

In a twelfth aspect, the one or more scheduling configurations includes at least one of a downlink scheduling configuration, an uplink scheduling configuration, a transmission scheduling configuration, or a reception scheduling configuration.

In a thirteenth aspect, the WUS is an LP-WUS.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, at a network node or an apparatus of a network node, in accordance with the present disclosure. Example process 800 is an example where the apparatus or the network node (e.g., network node 110) performs operations associated with a wakeup signal that indicates a scheduling configuration.

As shown in FIG. 8, in some aspects, process 800 may include transmitting an indication of one or more scheduling configurations (block 810). For example, the network node (e.g., using transmission component 1004 and/or communication manager 1006, depicted in FIG. 10) may transmit an indication of one or more scheduling configurations, as described above.

As further shown in FIG. 8, in some aspects, process 800 may include transmitting a WUS that indicates selection of a specific scheduling configuration in the one or more scheduling configurations (block 820). For example, the network node (e.g., using transmission component 1004 and/or communication manager 1006, depicted in FIG. 10) may transmit a WUS that indicates selection of a specific scheduling configuration in the one or more scheduling configurations, as described above.

Process 800 may include additional aspects, such as any single aspect or any combination of aspects described below and/or in connection with one or more other processes described elsewhere herein.

In a first aspect, the specific scheduling configuration is a downlink scheduling configuration, and process 800 includes transmitting a downlink communication using the downlink scheduling configuration.

In a second aspect, the specific scheduling configuration is an uplink scheduling configuration, and process 800 includes receiving an uplink communication using the uplink scheduling configuration.

In a third aspect, transmitting the indication of the one or more scheduling configurations includes transmitting the indication of the one or more scheduling configurations in RRC signaling.

In a fourth aspect, each scheduling configuration of the one or more scheduling configurations indicates a respective set of scheduling parameters.

In a fifth aspect, the respective set of scheduling parameters includes at least one of a time partition offset, a first quantity of time partitions, a resource offset, a second quantity of resources, a modulation and coding scheme, or a coding rate.

In a sixth aspect, the time partition offset is a symbol offset.

In a seventh aspect, the resource offset is a resource block offset.

In an eighth aspect, the resource offset is relative to a resource that is associated with receiving the WUS.

In a ninth aspect, the indication is a first indication, and process 800 includes receiving, prior to transmitting the first indication of the one or more scheduling configurations, a second indication of a capability to receive the WUS that indicates the selection of the specific scheduling configuration of the one or more scheduling configurations.

In a tenth aspect, transmitting the indication of the one or more scheduling configurations includes transmitting a table that indicates the one or more scheduling configurations, and the WUS indicates an index of an entry in the table that is associated with the specific scheduling configuration.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a UE, or a UE may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 150 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 140 described in connection with FIG. 1) of the UE.

In some aspects, the apparatus 900 may be configured to perform one or more operations described herein in connection with FIGS. 5-6. Additionally, or alternatively, the apparatus 900 may be configured to perform one or more processes described herein, such as process 700 of FIG. 7, or a combination thereof. In some aspects, the apparatus 900 and/or one or more components shown in FIG. 9 may include one or more components of the UE described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the UE described above in connection with FIG. 1, such as a radio, one or more RF chains, one or more transceivers, or one or more modems, each of which may in turn be coupled with one or more antennas of the UE.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 904 may be co-located with the reception component 902.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The reception component 902 may receive an indication of one or more scheduling configurations. The reception component 902 may receive a WUS that indicates selection of a specific scheduling configuration of the one or more scheduling configurations. In some aspects, the communication manager 906 may skip physical downlink control channel monitoring that is associated with the WUS based at least in part on the WUS indicating the specific scheduling configuration.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication, in accordance with the present disclosure. The apparatus 1000 may be a network node, or a network node may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 155 described in connection with FIG. 1. As shown, the apparatus 1000 may communicate with another apparatus 1008, such as a UE or a network node (such as a CU, a DU, an RU, or a base station), using the reception component 1002 and the transmission component 1004. The communication manager 1006 may be included in, or implemented via, a processing system (for example, the processing system 145 described in connection with FIG. 1) of the network node.

In some aspects, the apparatus 1000 may be configured to perform one or more operations described herein in connection with FIGS. 5-6. Additionally, or alternatively, the apparatus 1000 may be configured to perform one or more processes described herein, such as process 800 of FIG. 8, or a combination thereof. In some aspects, the apparatus 1000 and/or one or more components shown in FIG. 10 may include one or more components of the network node described in connection with FIG. 1. Additionally, or alternatively, one or more components shown in FIG. 10 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications, and may provide the processed signals to the one or more other components of the apparatus 1000. In some aspects, the reception component 1002 may include one or more components of the network node described above in connection with FIG. 1, such as a radio, one or more RF chains, one or more transceivers, or one or more modems, each of which may in turn be coupled with one or more antennas of the network node. In some aspects, the reception component 1002 and/or the transmission component 1004 may include or may be included in a network interface. The network interface may be configured to obtain and/or output signals for the apparatus 1000 via one or more communications links, such as a backhaul link, a midhaul link, and/or a fronthaul link.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications, and may transmit the processed signals to the apparatus 1008. In some aspects, the transmission component 1004 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1004 may be co-located with the reception component 1002.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The transmission component 1004 may transmit an indication of one or more scheduling configurations. The transmission component 1004 may transmit a WUS that indicates selection of a specific scheduling configuration in the one or more scheduling configurations.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:
Aspect 1: A method of wireless communication performed by a user equipment (UE), comprising: receiving an indication of one or more scheduling configurations; and receiving a wakeup signal (WUS) that indicates selection of a specific scheduling configuration of the one or more scheduling configurations.
Aspect 2: The method of Aspect 1, wherein the specific scheduling configuration is a downlink scheduling configuration, and wherein the method further comprises: receiving a downlink communication using the downlink scheduling configuration.
Aspect 3: The method of any of Aspects 1-2, further comprising: skipping physical downlink control channel monitoring that is associated with the WUS based at least in part on the WUS indicating the specific scheduling configuration.
Aspect 4: The method of any of Aspects 1-3, wherein the specific scheduling configuration is an uplink scheduling configuration, and wherein the method further comprises: transmitting an uplink communication using the uplink scheduling configuration.
Aspect 5: The method of any of Aspects 1-4, wherein receiving the indication of the one or more scheduling configurations comprises: receiving the indication of the one or more scheduling configurations in radio resource control (RRC) signaling.
Aspect 6: The method of any of Aspects 1-5, wherein each scheduling configuration of the one or more scheduling configurations indicates a respective set of scheduling parameters.
Aspect 7: The method of Aspect 6, wherein the respective set of scheduling parameters comprises at least one of: a time partition offset, a first quantity of time partitions, a resource offset, a second quantity of resources, a modulation and coding scheme, or a coding rate.
Aspect 8: The method of Aspect 7, wherein the time partition offset is a symbol offset.
Aspect 9: The method of Aspect 7 or Aspect 8, wherein the resource offset is a resource block offset.
Aspect 10: The method of any one of Aspects 7-9, wherein the resource offset is relative to a resource that is associated with receiving the WUS.
Aspect 11: The method of any of Aspects 1-10, wherein the indication is a first indication, and wherein the method further comprises: transmitting, prior to receiving the first indication of the one or more scheduling configurations, a second indication of a capability to receive the WUS that indicates the selection of the specific scheduling configuration of the one or more scheduling configurations.
Aspect 12: The method of any of Aspects 1-11, wherein receiving the indication of the one or more scheduling configurations comprises: receiving a table that indicates the one or more scheduling configurations, wherein the WUS indicates an index of an entry in the table that is associated with the specific scheduling configuration.
Aspect 13: The method of Aspect 12, wherein the one or more scheduling configurations includes at least one of: a downlink scheduling configuration, an uplink scheduling configuration, a transmission scheduling configuration, or a reception scheduling configuration.
Aspect 14: The method of any of Aspects 1-13, wherein the WUS is a low power wakeup signal (LP-WUS).
Aspect 15: A method of wireless communication performed by a network node, comprising: transmitting an indication of one or more scheduling configurations; and transmitting a wakeup signal (WUS) that indicates selection of a specific scheduling configuration in the one or more scheduling configurations.
Aspect 16: The method of Aspect 15, wherein the specific scheduling configuration is a downlink scheduling configuration, and wherein the method further comprises: transmitting a downlink communication using the downlink scheduling configuration.
Aspect 17: The method of any of Aspects 15-16, wherein the specific scheduling configuration is an uplink scheduling configuration, and wherein the method further comprises: receiving an uplink communication using the uplink scheduling configuration.
Aspect 18: The method of any of Aspects 15-17, wherein transmitting the indication of the one or more scheduling configurations comprises: transmitting the indication of the one or more scheduling configurations in radio resource control (RRC) signaling.
Aspect 19: The method of any of Aspects 15-18, wherein each scheduling configuration of the one or more scheduling configurations indicates a respective set of scheduling parameters.
Aspect 20: The method of Aspect 19, wherein the respective set of scheduling parameters comprises at least one of: a time partition offset, a first quantity of time partitions, a resource offset, a second quantity of resources, a modulation and coding scheme, or a coding rate.
Aspect 21: The method of Aspect 20, wherein the time partition offset is a symbol offset.
Aspect 22: The method of Aspect 20 or Aspect 21, wherein the resource offset is a resource block offset.
Aspect 23: The method of any one of Aspects 20-22, wherein the resource offset is relative to a resource that is associated with receiving the WUS.
Aspect 24: The method of any of Aspects 15-23, wherein the indication is a first indication, and wherein the method further comprises: receiving, prior to transmitting the first indication of the one or more scheduling configurations, a second indication of a capability to receive the WUS that indicates the selection of the specific scheduling configuration of the one or more scheduling configurations.
Aspect 25: The method of any of Aspects 15-24, wherein transmitting the indication of the one or more scheduling configurations comprises: transmitting a table that indicates the one or more scheduling configurations, wherein the WUS indicates an index of an entry in the table that is associated with the specific scheduling configuration.
Aspect 26: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-14.
Aspect 27: An apparatus for wireless communication at a device, the apparatus comprising one or more memories and one or more processors coupled to the one or more memories, the one or more processors configured to cause the device to perform the method of one or more of Aspects 1-14.
Aspect 28: An apparatus for wireless communication, the apparatus comprising at least one means for performing the method of one or more of Aspects 1-14.
Aspect 29: A non-transitory computer-readable medium storing code for wireless communication, the code comprising instructions executable by one or more processors to perform the method of one or more of Aspects 1-14.
Aspect 30: A non-transitory computer-readable medium storing a set of instructions for wireless communication, the set of instructions comprising one or more instructions that, when executed by one or more processors of a device, cause the device to perform the method of one or more of Aspects 1-14.
Aspect 31: A device for wireless communication, the device comprising a processing system that includes one or more processors and one or more memories coupled with the one or more processors, the processing system configured to cause the device to perform the method of one or more of Aspects 1-14.
Aspect 32: An apparatus for wireless communication at a device, the apparatus comprising one or more memories and one or more processors coupled to the one or more memories, the one or more processors individually or collectively configured to cause the device to perform the method of one or more of Aspects 1-14.
Aspect 33: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 15-25.
Aspect 34: An apparatus for wireless communication at a device, the apparatus comprising one or more memories and one or more processors coupled to the one or more memories, the one or more processors configured to cause the device to perform the method of one or more of Aspects 15-25.
Aspect 35: An apparatus for wireless communication, the apparatus comprising at least one means for performing the method of one or more of Aspects 15-25.
Aspect 36: A non-transitory computer-readable medium storing code for wireless communication, the code comprising instructions executable by one or more processors to perform the method of one or more of Aspects 15-25.
Aspect 37: A non-transitory computer-readable medium storing a set of instructions for wireless communication, the set of instructions comprising one or more instructions that, when executed by one or more processors of a device, cause the device to perform the method of one or more of Aspects 15-25.
Aspect 38: A device for wireless communication, the device comprising a processing system that includes one or more processors and one or more memories coupled with the one or more processors, the processing system configured to cause the device to perform the method of one or more of Aspects 15-25.
Aspect 39: An apparatus for wireless communication at a device, the apparatus comprising one or more memories and one or more processors coupled to the one or more memories, the one or more processors individually or collectively configured to cause the device to perform the method of one or more of Aspects 15-25.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories; and
one or more processors, coupled to the one or more memories, configured to cause the UE to:
receive an indication of one or more scheduling configurations; and
receive a wakeup signal (WUS) that indicates selection of a specific scheduling configuration of the one or more scheduling configurations.

2. The apparatus of claim 1, wherein the specific scheduling configuration is a downlink scheduling configuration, and
wherein the one or more processors are further configured to cause the UE to:
receive a downlink communication using the downlink scheduling configuration.

3. The apparatus of claim 1, wherein the one or more processors are further configured to cause the UE to:
skip physical downlink control channel monitoring that is associated with the WUS based at least in part on the WUS indicating the specific scheduling configuration.

4. The apparatus of claim 1, wherein the specific scheduling configuration is an uplink scheduling configuration, and
wherein the one or more processors are further configured to cause the UE to:
transmit an uplink communication using the uplink scheduling configuration.

5. The apparatus of claim 1, wherein the one or more processors, to cause the UE to receive the indication of the one or more scheduling configurations, are configured to cause the UE to:
receive the indication of the one or more scheduling configurations in radio resource control (RRC) signaling.

6. The apparatus of claim 1, wherein each scheduling configuration of the one or more scheduling configurations indicates a respective set of scheduling parameters.

7. The apparatus of claim 6, wherein the respective set of scheduling parameters comprises at least one of:
a time partition offset,
a first quantity of time partitions,
a resource offset,
a second quantity of resources,
a modulation and coding scheme, or
a coding rate.

8. The apparatus of claim 1, wherein the indication is a first indication, and
wherein the one or more processors are further configured to cause the UE to:
transmit, prior to receiving the first indication of the one or more scheduling configurations, a second indication of a capability to receive the WUS that indicates the selection of the specific scheduling configuration of the one or more scheduling configurations.

9. The apparatus of claim 1, wherein the one or more processors, to cause the UE to receive the indication of the one or more scheduling configurations, are configured to cause the UE to:
receive a table that indicates the one or more scheduling configurations,
wherein the WUS indicates an index of an entry in the table that is associated with the specific scheduling configuration.

10. The apparatus of claim 9, wherein the one or more scheduling configurations includes at least one of:
a downlink scheduling configuration,
an uplink scheduling configuration,
a transmission scheduling configuration, or
a reception scheduling configuration.

11. A method of wireless communication performed by a user equipment (UE), comprising:
receiving an indication of one or more scheduling configurations; and
receiving a wakeup signal (WUS) that indicates selection of a specific scheduling configuration of the one or more scheduling configurations.

12. The method of claim 11, wherein the specific scheduling configuration is a downlink scheduling configuration, and
wherein the method further comprises:
receiving a downlink communication using the downlink scheduling configuration.

13. The method of claim 11, further comprising:
skipping physical downlink control channel monitoring that is associated with the WUS based at least in part on the WUS indicating the specific scheduling configuration.

14. The method of claim 11, wherein the specific scheduling configuration is an uplink scheduling configuration, and
wherein the method further comprises:
transmitting an uplink communication using the uplink scheduling configuration.

15. The method of claim 11, wherein receiving the indication of the one or more scheduling configurations comprises:
receiving the indication of the one or more scheduling configurations in radio resource control (RRC) signaling.

16. The method of claim 11, wherein each scheduling configuration of the one or more scheduling configurations indicates a respective set of scheduling parameters.

17. The method of claim 11, wherein receiving the indication of the one or more scheduling configurations comprises:
receiving a table that indicates the one or more scheduling configurations,
wherein the WUS indicates an index of an entry in the table that is associated with the specific scheduling configuration.

18. A non-transitory computer-readable medium storing a set of instructions for wireless communication, the set of instructions comprising:
one or more instructions that, when executed by one or more processors of a user equipment (UE), cause the UE to:
receive an indication of one or more scheduling configurations; and
receive a wakeup signal (WUS) that indicates selection of a specific scheduling configuration of the one or more scheduling configurations.

19. The non-transitory computer-readable medium of claim 18, wherein the specific scheduling configuration is a downlink scheduling configuration, and
wherein the one or more instructions further cause the UE to:
receive a downlink communication using the downlink scheduling configuration.

20. The non-transitory computer-readable medium of claim 18, wherein the one or more instructions further cause the UE to:
skip physical downlink control channel monitoring that is associated with the WUS based at least in part on the WUS indicating the specific scheduling configuration.
